(19) United States
(12) Patent Application Publication
(10) Pub. No.: US 2011/0004917 A1
(43) Pub. Date: Jan. 6, 2011

(54) Integration Platform for Collecting Security Audit Trail

(75) Inventors: Lauri Saisa, Espoo (FI); Thomas Bergenwall, Espoo (FI)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/921,434

(22) PCT Filed: Mar. 13, 2008
(86) PCT No.: PCT/SE2008/050279

§ 371 Date: Sep. 8, 2010

(51) Int. Cl. G06F 21/00; G06F 15/173

(52) U.S. Cl. 726/1; 709/223; 726/22

(57) ABSTRACT

An audit processor is interposed between production servers and an auditing server, and is a client to both. The audit processor is an integration point, receiving security audit data from production servers, processing the data (e.g., converting the data from binary to text format), and sending processed audit trails to the auditing server. The audit processor includes data buffering capacity and flow control; accordingly, temporary unavailability of the auditing server does not impact the production servers. The production servers will purge stale audit data; accordingly, temporary unavailability of the audit processor does not impact the production servers. Since the audit processor may process security audit data according to any protocol or format imposed or requested by the auditing server; the production servers are unaffected by auditing server changes. The audit processor integrates production servers with existing auditing servers without jeopardizing the telecom grade availability of the wireless telecommunication network.

### TECHNICAL FIELD

The present invention relates generally to audits in telecommunication networks and in particular to an integration platform for collecting, processing, and forwarding audit data while maintaining telecom grade network availability.

### BACKGROUND

A security audit is an important part of the management and operation of a telecommunication network. A security audit is an independent review and examination of system records and activities. The industry standard, ITU-T X.816 (11/95) Information Technology—Open Systems Interconnection—Security Frameworks for Open Systems: Security Audit and Alarms Framework, describes a basic model for conducting a security audit for open systems.

A security audit is an independent review and examination of system records and activities. The purposes of a security audit include:

assisting in the identification and analysis of unauthorized actions or attacks;

helping ensure that actions can be attributed to the entities responsible for those actions;

contributing to the development of improved damage control procedures;

confirming compliance with established security policy;

reporting information that may indicate inadequacies in system controls; and

identifying possible required changes in controls, policy and procedures.

A security audit comprises the detection, collection, and recording of various security-related events in a security audit trail, and analysis of those events. A security audit thus requires that information be recorded. A security audit ensures that sufficient information is recorded about both routine and exceptional events so that later investigations can determine if security violations have occurred and, if so, what information or other resources have been compromised. Such events may include, for example, logins and unsuccessful login attempts, the reading and/or modification of files, the execution of commands, and the like.

FIG. 1 (which is FIG. 2 of the ITU-T X.816 standard) depicts a typical configuration. Network systems A and B collect audit trails, and send them via an audit dispatcher function to a central audit trail collector function in system C (referred to herein as an auditing server), which collects, analyzes, and archives the audit trails. As FIG. 1 indicates, audit trails may be collected from several different sources. This technology is widely deployed in wireless telecommunication service providers' production networks, as well as in enterprise networks. Production networks comprise primarily servers (production servers), while enterprise networks are typically a mix of servers, workstations, and peripherals. The capacity and stability of the system relies heavily on the auditing server (i.e., system C) that collects and archives the auditing information. In enterprise networks, the auditing server may collect audit trails from numerous audit dispatchers in the network, which are clients to the auditing server. Integration may be done in the client or in the server.

However, when such an auditing system is applied to the production network of a wireless telecommunication service provider, the telecom service may degrade. In particular, the telecom grade availability—99.999% availability of the planned uptime—may become impossible to reach. This poses a high risk of service downgrade, for example, wireless services may become unavailable for some mobile users.

The source of the service downgrade is the auditing server, to which associated production servers are clients for the transfer of audit trails. If the auditing server is unavailable, such as for maintenance or during a reboot, the productions servers must ensure that the audit trail is securely transferred. Furthermore, adding a production server as a new “client” to the auditing server (that is, a new source of audit trails) may introduce incompatibilities or errors in the data. This is because the integration of the client may be done in the auditing server or in the new client (production server). Any problem in the auditing server may result in a reboot, which will adversely impact other production servers as they attempt to dispatch audit trails to the auditing server. In short, even a temporary degradation in performance or unavailability of the auditing server can drag the telecom grade availability to below its targeted 99.999%.

### SUMMARY

A new network entity, the audit processor, is a client both to production servers and to an auditing server. The audit processor is an integration point, receiving security audit data from production servers, processing the data (e.g., converting the data from binary to text format), and sending processed audit trails to the auditing server. The audit processor includes data buffering capacity and flow control; accordingly, temporary unavailability of the auditing server does not impact the production servers. The production servers will purge stale audit data; accordingly, temporary unavailability of the audit processor does not impact the production servers. Since the audit processor may process security audit data according to any protocol or format imposed or requested by the auditing server; the production servers are unaffected by auditing server changes. The audit processor integrates production servers with existing auditing servers without jeopardizing the telecom grade availability of the wireless telecommunication network.

One embodiment relates to a method of collecting audit data in a wireless telecommunication production network. One or more audit data records are fetched from a production server in the production network, each audit data record comprising records of security-related events compiled by the production server. The audit data record is processed in an audit processor that is a client to both the production server and an auditing server. The audit data record is dispatched from the audit processor to the auditing server.

Another embodiment relates to an audit processor for conducting security audits in a wireless telecommunication production network while maintaining telecom grade availability. The audit processor includes means for processing audit data; data storage configured as an unprocessed audit data record queuing stage; data storage configured as a processed audit data record queuing stage; and one or more controllers. The controllers are operative as clients to fetch an audit data record from a production server in the production network; and dispatch the audit data record to an auditing server.

Yet another embodiment relates to a telecommunication production network. The network includes one or more production servers operative to monitor and record security-related events as a plurality of audit data records. The network also includes an auditing server operative to store audit data records as one or more audit trails, and further operative to perform security audits on the audit trails. The network further includes an audit processor acting as a client to the one or more production servers and the auditing server, and operative to fetch audit data records from the production servers, process the audit data records, and dispatch processed audit data records to the auditing server.

### BRIEF DESCRIPTION OF THE DRAWINGS

FIG. 1 is a functional block diagram of a prior art security auditing system.

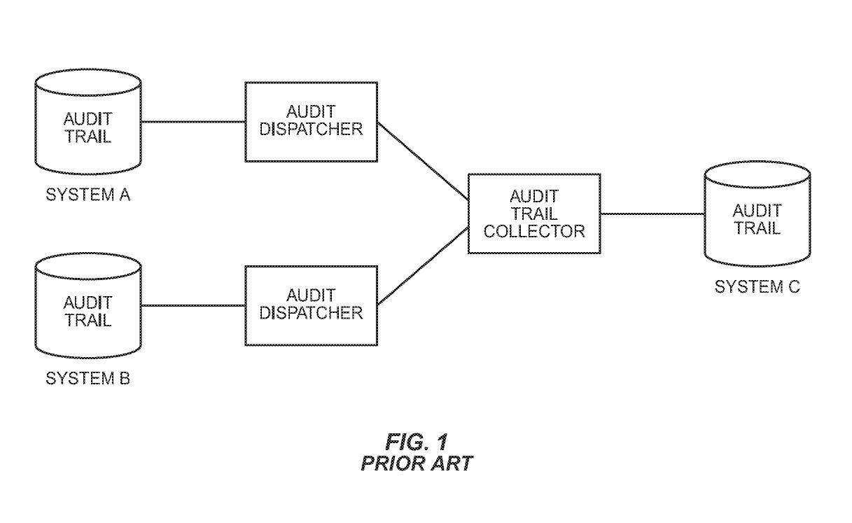

FIG. 2 is a functional block diagram of a network including an audit processor.

FIG. 3 is a functional block diagram of queuing stages of audit data records in a charging system.

FIG. 4 is a functional block diagram of an audit processor.

FIG. 5 is a functional block diagram of an auditing server.

FIG. 6 is a flow diagram of a method of performing security audits.

### DETAILED DESCRIPTION

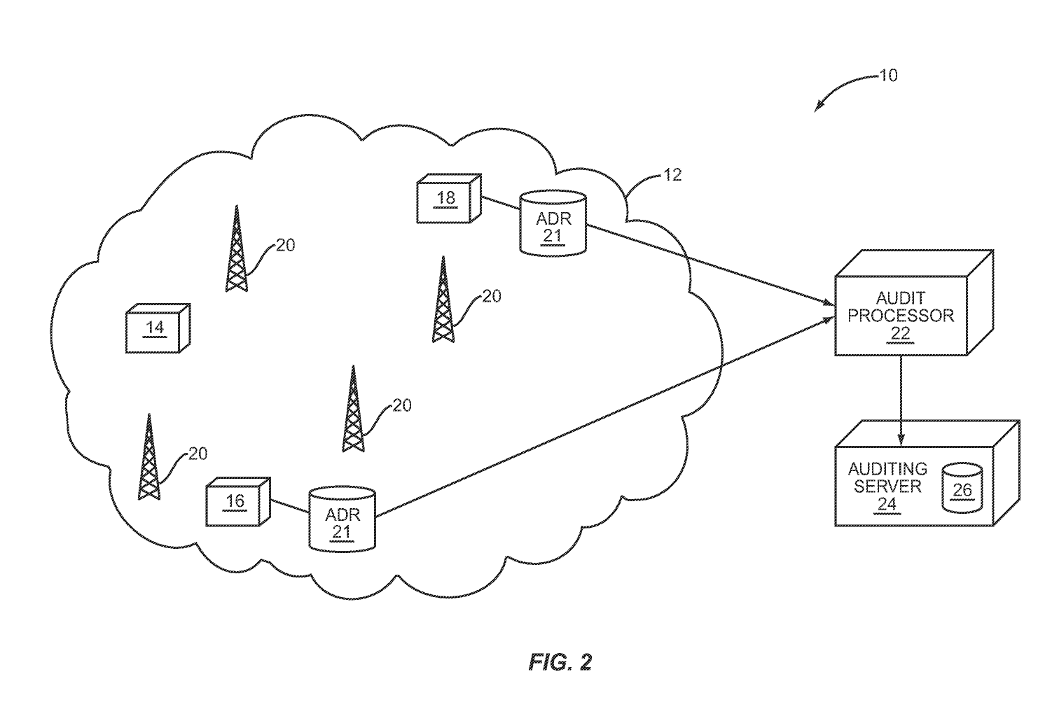

FIG. 2 depicts a network configured for performing security audits while maintaining telecom grade network availability. A wireless telecommunication service provider production network 12 includes a plurality of production servers 14, 16, 18 and a plurality of radio transceivers 20 providing wireless communications services over predefined geographic areas (cells). One or more of the production servers 16, 18 include a dedicated data storage area 21 where audit data is collected. The audit data is sent, in the form of audit data records (ADR), to an audit processor 22.

The audit processor 22, which is a client to the production servers 16, 18, fetches ADRs from the production servers 16, 18, processes the ADRs, and sends the processed ADRs to an auditing server 24, which includes long-term audit data storage 26. The processing of ADRs may include operations such as converting audit data from binary to text format, or otherwise processing audit data according to specifications and protocols required or preferred by the auditing server 24. Offloading this data processing task from the production servers 16, 18 to the audit processor 22 removes a computational load from the production servers 16, 18, allowing them to dedicate full computational resources to production tasks. Processing at production servers 16, 18 is limited to simple tasks to compile audit data at a protected area from where the audit processor can fetch the data. Another advantage of processing ADRs in the audit processor 22 is that changes to the specifications and protocols required or preferred by the auditing server 24 may be implemented without any impact to the production servers 16, 18.

The audit processor 22 includes data buffering capacity, so a temporary unavailability of the auditing server 24 does not impact the production servers 16, 18. The production servers 16, 18 include dedicated audit data storage 21. Data management agents running on the production servers 16, 18 monitor ADR collection and storage, and perform data maintenance. For example, the agents may delete old backup files, or suspend audit data collection if the disk storage 21 is insufficient. The agents may monitor and delete queued ADRs that have not been transferred to the audit processor 22 for a predetermined duration (e.g., two days), and otherwise insulate the production servers 16, 18 from any effects of ADR collection, storage, processing, or transfer to the auditing server 24. Accordingly, temporary unavailability of the audit processor 22 does not adversely impact the production servers 16, 18.

It is noticed that the audit processor 22 is a client both to production servers 16, 18, thereby capable of obtaining/requesting there from data and exemplary queue status, and to the auditing server 24. The audit processor 22 is an integration platform between the telecom grade production servers 16, 18 and the non-telecom grade auditing server 24.

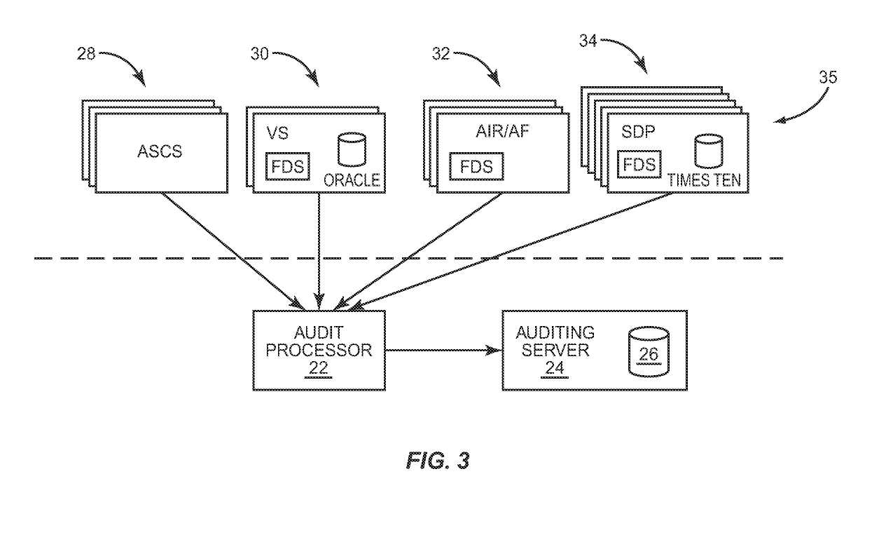

FIG. 3 depicts a functional block diagram of an interface between a production server 16, 18 implementing a telecommunication charging system and the audit processor 22. A charging system is a large, complex, real-time, recordkeeping and transactional system that tracks telecom service usage and bills for it. Performing security audits in a charging system is critical to detect erroneous and/or fraudulent accesses, transactions, billings, and the like. A charging system may include a plurality of nodes, or processes, each of which may generate its own audit data in the form of ADRs. While the structure and operation of the present invention is described herein with respect to a telecom charging system, the present invention is not so limited. In general, any production network may advantageously employ the teachings of the present disclosure to increase network availability by offloading audit data collection, processing, and forwarding from production servers 16, 18 to an audit processor 22.

FIG. 3 depicts a queue 28 of ADRs from an ASCS (Admin System for Charging Systems) node, a queue 30 of ADRs from a VS (Voucher Server) node, a queue 32 of ADRs from an AIR/AF (Account Information & Refill/Account Finder) node, and a queue 34 of ADRs from an SDP (Service Delivery Platform) node. The VS, AIR/AF, and SDP ADRs may include audit data from an FDS (Fraud Detection System) component. The SDP ADRs may include audit data from a Times Ten® database, and the VS ADRs may include audit data from an Oracle® database. The charging system nodes and types of ADRs generated are exemplary only.

In FIG. 3, the area above the dashed line depicts the access domain of the charging system administrator; the area below the dashed line depicts the access domain of a security auditor. The charging server(s) 16, 18 running the charging system transfer data to the queues 28, 30, 32, 34 to be fetched by the audit processor 22. The queues 28, 30, 32, 34 depict a first queuing stage 35—the first of four queuing stages maintained in the ADR processing chain according to one embodiment of the present invention. These are:

Available ADRs at the production server 16, 18 (waiting to be fetched);

Unprocessed ADRs at the audit processor 22 (waiting to be processed);

Processed ADRs at the audit processor 22 (waiting to be dispatched); and

Processed ADRs at the auditing server (waiting to be loaded into an audit trail database).

These independent queuing stages decouple the production servers 16, 18, the audit processor 22, and the auditing server 24 from each other (and further, decouple fetch, process, and dispatch processes within the audit processor 22, as further described herein), such that the temporary unavailability of either the audit processor 22 or the auditing server 24 does not negatively impact the production servers 16, 18.

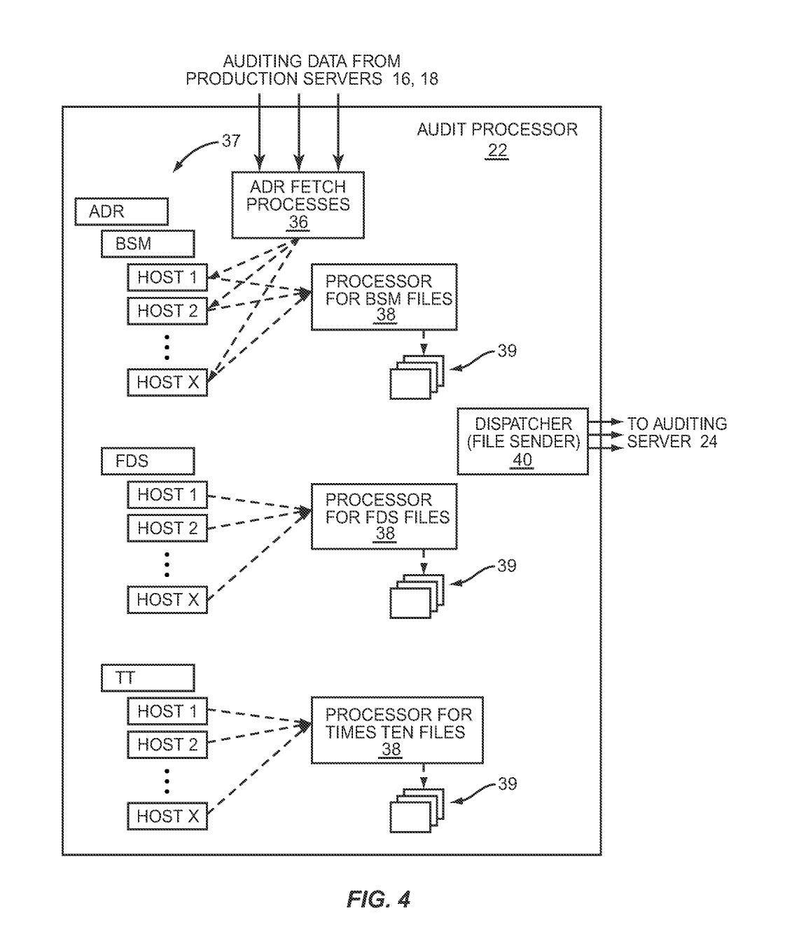

FIG. 4 depicts a functional block diagram of the audit processor 22. The audit processor 22 in this embodiment processes ADRs for a plurality of production servers 16, 18 (labeled host1, host2, . . . , hostx) related to three audited modules: BSM (Basic Security Module), FDS, and Times Ten. BSM is a module in the Solaris® operating system, available from Sun Microsystems®, that creates a detailed audit trail (e.g., at the DoD “C2” certification level) for all processes running on the operating system. FDS is a module that monitors ongoing calls to detect and report potentially fraudulent call activity. Times Ten is an in-memory, embeddable, relational database with very fast response time. Of course, these software modules are only representative of applications that may generate audit data, and do not limit the scope of the present invention in any way.

As depicted in FIG. 4, auditing data in the form of ADRs is received from charging system nodes running on one or more production servers 16, 18, by an ADR client operation “fetch” process 36. The fetch process 36 fetches ADRs from the available ADR queuing stage 35 at the production servers 16, 18, and stores them in an unprocessed ADR queuing stage 37. In the embodiment depicted in FIG. 4, the unprocessed ADR queuing stage 37 is structured as a hierarchical file system, with ADRs from each production server 16, 18 (i.e., host1, host2, . . . , hostx) grouped together under the three representative audited modules (BSM, FDS, and Times Ten). The ADRs in the unprocessed queuing stage 37 may, of course, be organized in a different logical structure.

The auditing processor 22 may, as a client to a production server, obtain/request information about queuing state for adapting/adjusting/controlling the fetch process 36, exemplary determining frequency of fetch operations or time to perform a fetch operation.

Three “process” processes 38 retrieve ADRs from the unprocessed queuing stage 37, and process the ADRs, writing output to three respective queues that collectively form the processed ADR queuing stage 39. ADR processing may comprise transforming data in ADRs between formats (e.g., binary to text), formatting ADR data according to auditing server 24 protocols, range-checking and/or filtering ADR data, and the like. In general, the processes 38 may process the ADRs in any manner as required or desired for a particular application. As depicted in FIG. 4, separate processes 38 may execute to process ADRs from different audited modules. Alternatively, one process 38 may adaptively process ADRs related to two or more, or all, audited modules.

A client operation “dispatch” process 40 retrieves ADRs from the processed ADR queuing stage 39, and forwards them to the auditing server 26. The processes 36, 38, 40 may execute as separate software tasks or modules on one or more processors, or may execute independently on separate processors. The processes 36, 38, 40 may comprise software modules executing on one or more stored-program processors, or may alternatively comprise dedicated hardware circuits, or any combination of hardware, software, and firmware.

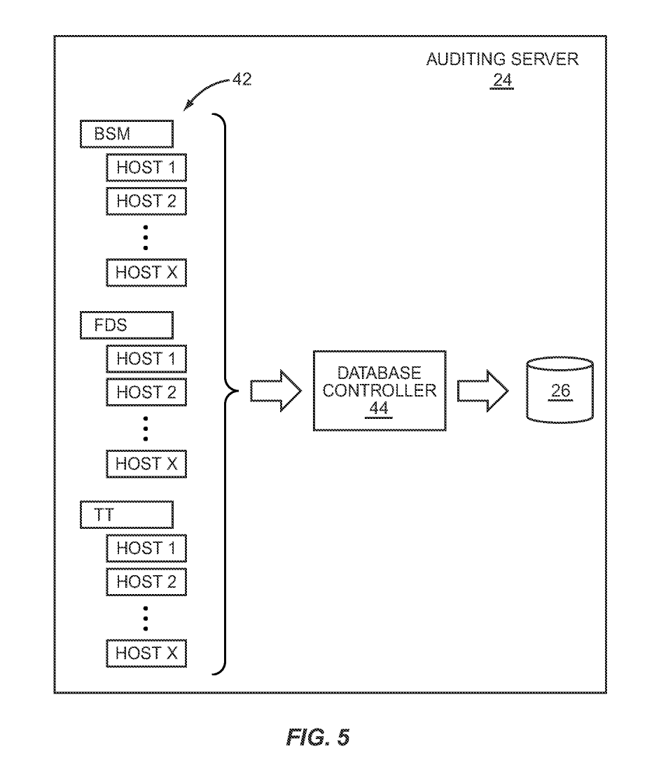

In the embodiment depicted in FIG. 4, the audit processor 22 executes three distinct processes on each ADR: fetch 36, process 38, and dispatch 40. The processes occur interstitially to the four ADR queuing stages defined above. That is, an ADR is retrieved from an available ADR queuing stage 35 at the production server 16, 18 by the “fetch” process 36, which writes it to the unprocessed ADR queuing stage 37. The ADR is retrieved from the unprocessed ADR queuing stage 37 by the “process” process 38, which processes the ADR and writes it to the processed ADR queuing stage 39. The ADR is then retrieved from the processed ADR queuing stage 39 by the “dispatch” process 40, which writes it to a processed ADR queuing stage 42 (see FIG. 5) at the auditing server 24.

FIG. 5 depicts processed ADRs retrieved from the audit processor 22 stored in a processed ADR queuing stage 42 at the auditing server 26. The processed ADR queuing stage 42 at the auditing server 24 may have the same logical structure as the unprocessed ADR queuing stage 37 and/or processed ADR queuing stage 39 at the audit processor 22, as depicted in FIG. 5. Alternatively, the ADRs in the processed ADR queuing stage 42 may be organized according to any logical structure, as required or desired. A module, such as a database controller 44, retrieves ADRs from the processed ADR queuing stage 42, and loads them into an audit trail database 26 for long-term storage and retrieval for analysis during security audits.

In transferring ADRs between production servers 16, 18, the audit processor 22, and the auditing server 24, the audit data must be protected against unauthorized disclosure and/or modification, to preserve the integrity of a subsequent security audit. Accordingly, these network entities may be interconnected via secure links, and/or the ADRs may be encrypted and may include redundant data to detect and/or correct transmission errors. Furthermore, each of the production servers 16, 18, the audit processor 22, and the auditing server 24 should have full confidence that the source and destination of the data transfers are as claimed and that the ADRs have not been corrupted in any manner. A variety of known access control, confidentiality, integrity, and authentication mechanisms may be employed to ensure that the security audit trail is protected from unauthorized disclosure and/or modification.

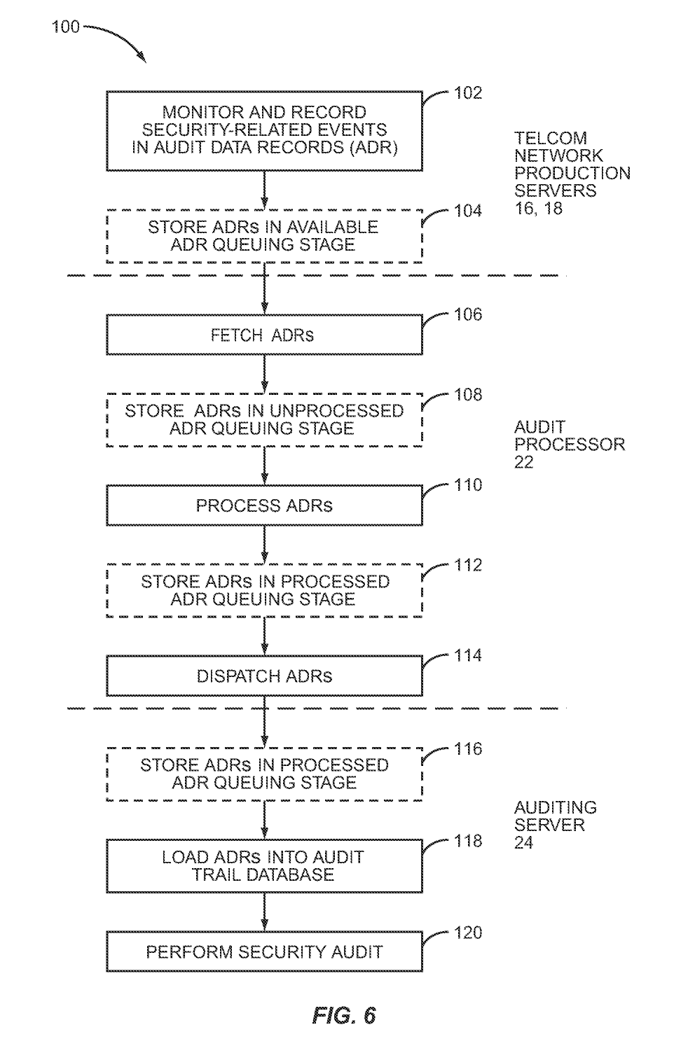

FIG. 6 depicts a flow diagram of a method 100 of performing security audits in a wireless telecommunications service provider's production network while maintaining telecom grade availability. The method steps are grouped by dashed lines to indicate which network entity—the production servers 16, 18, the audit processor 22, or the auditing server 24—performs each step. Optional steps—that is, those method steps that may be omitted in one or more embodiments—are depicted using dashed-line boxes. Although depicted as a single flow of sequential steps, those of skill in the art will readily recognize that the monitoring, collection, processing, transfer, storage, and analysis of security audit data is a continuous, ongoing process.

With this in mind, the method may be said to begin when one or more production servers 16, 18 monitor security-related events, and record the events in audit data records (block 102). The audit data is stored in an available ADR queuing stage 35 at the production servers 16, 18 (block 104). A data management agent running on the production servers 16, 18 may monitor the available ADR queuing stage, and take steps to ensure that the collection and storage of ADRs does not adversely impact applications running on the production servers 16, 18 (such as a charging system). These steps may include deleting old files, deleting ADRs in the event the audit processor 22 is unavailable, and the like.

The audit processor 22 fetches ADRs from the available ADR queuing stage 35 at one or more production servers 16, 18 (block 106). The audit processor 22 stores the ADRs in an unprocessed ADR queuing stage 37 at the audit processor 22 (block 108). The audit processor 22 then retrieves ADRs from the unprocessed ADR queuing stage 37 and processes the ADRs (block 110). The processing may comprise filtering the audit data, reformatting it, or other operations. The audit processor 22 stores the processed ADRs in a processed ADR queuing stage 39 (block 112), then retrieves the ADRs from the processed ADR queuing stage 39 and dispatches them to the auditing server 24 (block 114).

Upon receiving ADRs from the audit processor 22, the auditing server 24 stores the ADRs in a processed ADR queuing stage 42 at the auditing server 24 (block 116). The auditing server 24 and retrieves ADRs from the processed ADR queuing stage 42 and loads them into an audit trial database 26 (block 118). The auditing server 24 may then retrieve audit trails from the database 26 and perform a security audit (block 120).

By performing the fetching, processing, and dispatch of audit data in an audit processor 22 interposed between telecom grade production servers 16, 18 and an auditing server 24, compute resources on the production servers 16, 18 may be more fully dedicated to running applications, such as a charging system. Furthermore, by storing audit data in queuing stages, the production servers 16, 18 are insulated from the effects of temporary unavailability of the auditing server 24 or the audit processor 22. This allows the production network to achieve and maintain an extremely high availability, such as the telecom grade of 99.999% availability.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-13. (canceled)

14. A method of collecting audit data in a wireless telecommunication production network, comprising:
fetching one or more audit data records from a production server in the production network, each audit data record comprising records of security-related events compiled by the production server;
processing the one or more audit data records in an audit processor that is a client to both the production server and an auditing server; and
dispatching the one or more audit data records from the audit processor to the auditing server.

15. The method of claim 14, further comprising, if the auditing server is unavailable, storing the one or more audit data records at the audit processor.

16. The method of claim 14, wherein fetching one or more audit data records from a production server comprises fetching the one or more audit data records from an available audit data record queuing stage at the production server.

17. The method of claim 16, further comprising obtaining queuing information from the production server by the audit processor for controlling the fetching of the one or more audit data records.

18. The method of claim 14, wherein processing the one or more audit data records in the audit processor comprises:
storing the one or more audit data records in an unprocessed audit data record queuing stage prior to processing the one or more audit data records; and
storing the one or more audit data records in a processed audit data record queuing stage after processing the one or more audit data records.

19. The method of claim 18, wherein dispatching the one or more audit data records from the audit processor to an auditing server comprises:
fetching the one or more audit data records from the processed audit data record queuing stage; and
transferring the one or more audit data records to the auditing server.

20. An audit processor for conducting security audits in a wireless telecommunication production network while maintaining telecom grade availability, said audit processor comprising:
data storage configured as an unprocessed audit data record queuing stage;
data storage configured as a processed audit data record queuing stage; and
one or more controllers operative as clients to:
fetch an audit data record from a production server in the production network;
process the audit data record; and
dispatch the audit data record to an auditing server.

21. The audit processor of claim 20, wherein the one or more controllers are further operative to store the fetched audit data record in the unprocessed audit data record queuing stage prior to processing the audit data record, and to store the processed audit data record in the processed audit data record queuing stage after processing the audit data record and prior to dispatching the audit data record to the auditing server.

22. The audit processor of claim 20, wherein the audit processor fetches the audit data record from an available audit data record queuing stage at the production server.

23. The audit processor of claim 20, wherein the fetch process is adapted to obtain a queuing status at the production server for control of the fetch process.

24. A telecommunication production network comprising:
one or more production servers operative to monitor and record security-related events as a plurality of audit data records;
an auditing server operative to store the plurality of audit data records as one or more audit trails, and further operative to perform security audits on the audit trails; and
an audit processor acting as a client to the one or more production servers and the auditing server, and operative to fetch the plurality of audit data records from the production servers, process the plurality of audit data records, and dispatch the plurality of processed audit data records to the auditing server.

25. The network of claim 24, wherein each production server stores the plurality of audit data records in an available audit data record queuing stage at the production server.

26. The network of claim 24, wherein the audit processor stores the plurality of audit data records in an unprocessed audit data record queuing stage prior to processing the plurality of audit data records, and stores the plurality of audit data records in a processed audit data record queuing stage after processing the plurality of audit data records.
